(19) United States
(12) Patent Application Publication
(10) Pub. No.: US 2026/0352544 A1
(43) Pub. Date: Nov. 5, 2026

(54) ABNORMAL NODE SPECIFYING DEVICE, PROGRAM, AND ABNORMAL NODE SPECIFYING METHOD

(71) Applicant: NTT, Inc., Tokyo (JP)

(72) Inventors: Kazuma KAMIENOO, Musashino-shi, Tokyo (JP); Ken TAKAHASHI, Musashino-shi, Tokyo (JP); Taku KIHARA, Musashino-shi, Tokyo (JP)

(21) Appl. No.: 19/099,983

(22) PCT Filed: Aug. 8, 2022
(86) PCT No.: PCT/JP2022/030240

§ 371 Date: Jan. 30, 2025

(51) Int. Cl. H04L 41/0677; H04L 43/12

(52) U.S. Cl. CPC H04L 41/0677; H04L 43/12

(57) ABSTRACT

An abnormal node specification device (100) includes a measurement unit (112) that transmits a first test packet to be folded back at a first node that is an end point of a link of a network (300) and a second test packet to be folded back at a second node that is another end point through the first node and the link, and judges whether the link is communication OK, communication NG, or a measurement failure in accordance with return status of two test packets. In addition, the abnormal node specification device (100) includes an analysis unit (113) that judges that the node is abnormal when a link which is communication NG is present in links connected to the node of the network (300) and a link connected to the node other than the links is the measurement failure.

### TECHNICAL FIELD

The present invention relates to an abnormal node specification device, a program, and an abnormal node specification method for specifying an abnormal node in a communication network.

### BACKGROUND ART

A utilization form of the communication network (also simply referred to as a network) such as IoT (Internet of Things) and e-Sport has been diversified. In addition, network slicing is utilized in the fifth-generation mobile communication system. For this reason, the network needs to respond to various requests such as broadband, multi-terminal connection, and low delay. Since a carrier network is required to respond to these requests with high reliability, it is important for a network operator to constantly grasp network status, and to quickly specify and restore a fault location in an event of abnormality such as a fault.

As a technique for detecting the abnormality of a communication node (simply referred to as a node) on a router, a transmission device, and the like, a technique for measuring network quality such as delay and a packet loss by making a test packet to flow between the nodes is standardized (see NPL 1). A section where the abnormality occurs can be detected by communication availability of the test packet or the like. On the other hand, since there is a difference in node internal processing between the test packet of node arrival and departure and a user packet (packet including user data), there is a case in which the abnormality occurring only at a portion through which the user packet passes cannot be detected only by the test packet of node arrival and departure.

By installing a test device at an end point of measurement section, the test packet can be made to flow to the same path as the path through which the user packet flows. However, it is expensive to install test devices in all measurement sections in the network of several thousand scales like the carrier network.

As a technique for solving these problems, there is a measurement system described in NPL 2. By transmitting and receiving the test packet from the measurement system installed at one location of the network, quality such as delay and a packet loss in an arbitrary section can be measured.

### CITATION LIST

### Non Patent Literature

[NPL 1] K. Hedayat, et. al, Two-Way Active Measurement Protocol, RFC 5357, Internet Engineering Task Force, October 2008.
[NPL 2] Kazuma Kamienoo, and others, “Optimization scheme proposal and evaluation of delay measurement path”, IEICE General Conference, B-6-70, March 2021.

### SUMMARY OF INVENTION

### Technical Problem

According to the technique described in NPL 2, although delay and the packet loss in an arbitrary section (link) can be measured by one measurement system installed in the network, there is no mechanism for detecting the packet loss and detecting the abnormality of node. For this reason, even if the abnormality occurs in transfer processing of node, it is impossible to determine at which node the abnormality occurs. Therefore, a technique for specifying the abnormal node at a low cost is required.

The present invention has been made in view of such a background, and an object of the present invention is to enable the specification of abnormal node at the low cost.

### Solution to Problem

In order to solve the above problem, an abnormal node specification device according to the present invention includes a measurement unit that transmits a first test packet to be folded back at a first node which is an end point of a link of a network and a second test packet to be folded back at a second node which is another end point through the first node and the link, judges that the link is communication OK when the second test packet is returned, judges that the link is communication NG when the first test packet is returned and the second test packet is not returned, and judges that the link is a measurement failure when neither the first test packet nor the second test packet is returned, and an analysis unit that judges that the node is abnormal when a link which is communication NG is present in links connected to the node of the network and a link connected to the node other than the link is the measurement failure.

### Advantageous Effects of Invention

According to the present invention, it is possible to specify the abnormal node at the low cost.

### BRIEF DESCRIPTION OF DRAWINGS

FIG. 1 is a functional block diagram of an abnormal node specification device according to a present embodiment.

FIG. 2 is a diagram showing a network configuration according to the present embodiment.

FIG. 3 is a data configuration diagram of a measurement result database according to the present embodiment.

FIG. 4 is a diagram showing a test packet configuration according to the present embodiment.

FIG. 5 is a flowchart of measurement processing according to the present embodiment.

FIG. 6 is a flowchart of abnormal node specification processing according to the present embodiment.

FIG. 7 is a flowchart of node judgement processing according to the present embodiment.

FIG. 8 is a diagram showing a communication measurement result immediately after occurrence of abnormality in the node according to the present embodiment.

FIG. 9 is a diagram showing the communication measurement result after one round of the occurrence of abnormality in the node according to the present embodiment.

FIG. 10 is a diagram showing the communication measurement result after two rounds of the occurrence of abnormality in the node according to the present embodiment.

FIG. 11 is a hardware configuration diagram showing one example of a computer that realizes functions of the abnormal node specification device according to the present embodiment.

### DESCRIPTION OF EMBODIMENTS

An abnormal node specification device of a network in a form (embodiment) for carrying out the present invention will be described below. Note that it is assumed that a traffic engineering mechanism such as SR (Segment Routing) can be utilized for the network. That is, it is assumed that a label indicating a node for relaying a packet including a test packet is embedded in the packet, so that the packet can be relayed along an arbitrary communication path.

The abnormal node specification device is connected to one location of the network, transmits the test packet, and judges whether or not a packet loss is present in all links in the network. The abnormal node specification device transmits, for each link, a first test packet to be folded back at one end point and a second test packet to be folded back at the other end point through the end point and the link. The abnormal node specification device judges that the link is communication OK when the second test packet is returned. The abnormal node specification device judges the link is communication NG, in which the first test packet is returned and the second test packet is not returned. In addition, the abnormal node specification device judges that the link is a measurement failure, in which neither the first test packet nor the second test packet is returned. The abnormal node specification device judges that the node is abnormal when all links connected to the node are communication NG or measurement failures and one or more links are communication NG.

Such an abnormal node specification device can specify the abnormal node on the basis of whether or not the communication of link is present. Thus, only one abnormal node specification device needs to be installed in the network, and the abnormal node can be specified at the low cost. In addition, since transfer processing equivalent to the user packet is performed in the test packet, the abnormality of node which affects the user packet transfer processing and cannot be detected by intra-node monitoring can be detected. Further, by testing all paths including a standby path through which the user packet does not pass normally, abnormality detection of the standby path can be performed. By constantly monitoring the node by using the abnormal node specification device, such a node abnormality that cannot be detected by a node monitoring function is detected, and the abnormal node specification can be quickly performed.

### Configuration of Abnormal Node Specification Device

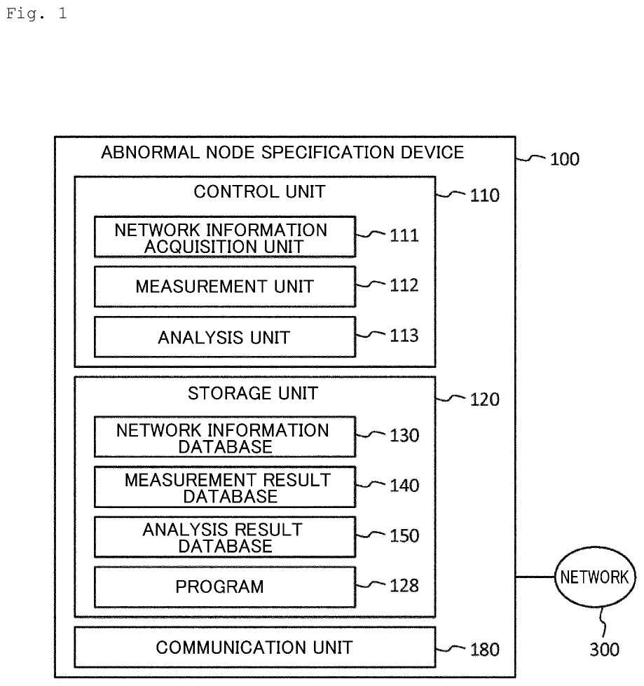

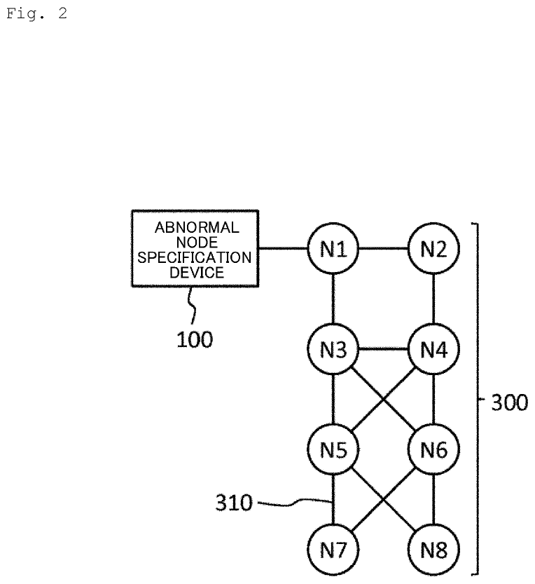

FIG. 1 is a functional block diagram of an abnormal node specification device 100 according to the present embodiment. The abnormal node specification device 100 is a computer connected to a network 300 to be monitored. FIG. 2 is a diagram showing a configuration of the network 300 according to the present embodiment. The node N1 to node N8 are nodes of a router, a transmission device, and the like, and lines between the nodes indicate links. In the following description, it is assumed that the network 300 is configured by the nodes and links shown in FIG. 2.

Returning to FIG. 1, the configuration of the abnormal node specification device 100 will be described. The abnormal node specification device 100 includes a control unit 110, a storage unit 120, and a communication unit 180. The communication unit 180 includes a communication device and can transmit and receive packets to and from other devices such as a node N1 to node N8 configuring the network 300 and a terminal (not shown) of a user (manager of the network 300) of the abnormal node specification device 100.

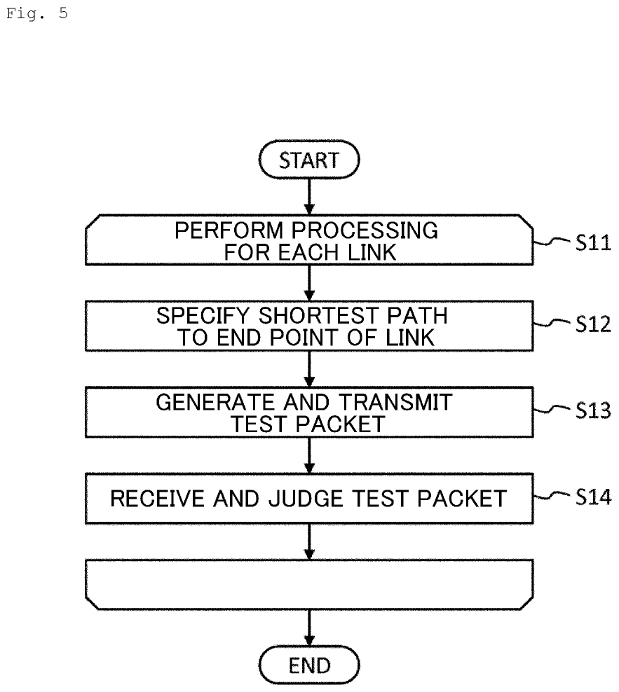

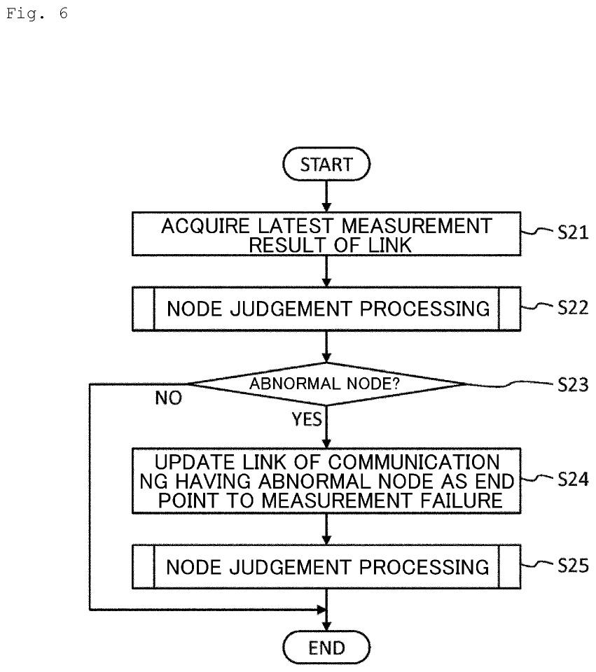

The storage unit 120 is configured to include storage equipment such as a ROM (Read Only Memory), a RAM (Random Access Memory), and an SSD (Solid State Drive). The storage unit 120 stores a network information database 130, a measurement result database 140, an analysis result database 150, and a program 128. The program 128 includes descriptions of procedure of measurement processing (see FIG. 5) and abnormal node specification processing (see FIG. 6), which will be described later.

The network information database 130 stores the configuration of network 300. In detail, the network information database 130 stores information on nodes configuring the network 300 and links connecting the nodes. The link information includes cost information in addition to the nodes to which the links are connected. By referring to these pieces of information, it is possible to specify the shortest path (path whose cost is the minimum) between the arbitrary nodes.

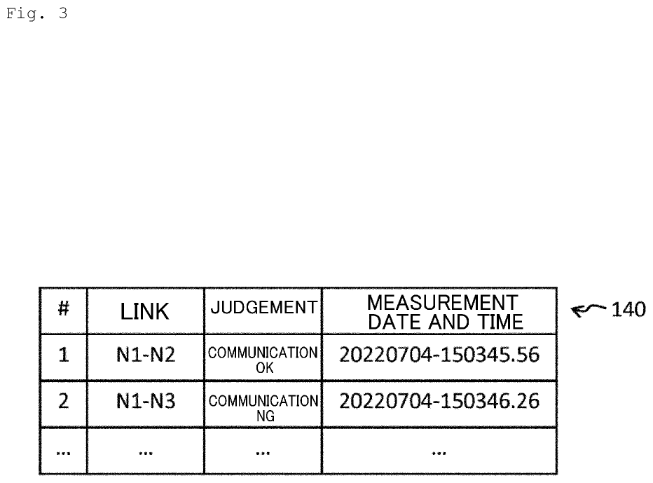

The measurement result database 140 (see FIG. 3) will be described later. In the analysis result database 150, information on the node judged to be abnormal is stored in association with a judgement time point.

FIG. 3 is a data configuration diagram of the measurement result database 140 according to the present embodiment. The measurement result database 140 is, for example, tabular data, and stores whether or not the communication of link is present. A row (record) of the measurement result database 140 includes a column (attribute) of an identification number (described as “#” in FIG. 3), a link, a judgement, and a measurement date and time.

The identification number indicates the identification number of record. The link indicates nodes at both ends of the link. The judgement indicates whether or not the communication of link is present (“communication OK” or “communication NG”) or communication is not judged (“measurement failure”). The measurement date and time indicates a date and time when the communication of link is judged. A measurement means will be described later (see the measurement unit 112).

### Control Unit

Returning to FIG. 1, the control unit 110 will be described. The control unit 110 is configured to include a CPU (Central Processing Unit), and includes a network information acquisition unit 111, a measurement unit 112, and an analysis unit 113. The network information acquisition unit 111 acquires connection information (topology information) of the nodes and links of network 300 and the link cost, and stores them in the network information database 130. The network information acquisition unit 111 acquires the topology information and the link cost by acquiring, for example, information on OSPF (Open Shortest Path First) and BGP-LS (Border Gateway Protocol—Link State) from the nodes of network 300.

The measurement unit 112 judges the communication of link of network 300. In detail, the measurement unit 112 transmits the first test packet to be folded back at one node which is the end point of link which is a judgement target. When determining the path of first test packet, the measurement unit 112 refers to the measurement result database 140 (see FIG. 3) to acquire the judgement result of the latest link, and determines the path so as to avoid the link which is communication NG. In addition, the measurement unit 112 transmits the second test packet to be folded back at the other node of link through the node and link. The path to node is the same as that of the first test packet.

The measurement unit 112 judges that the link is communication OK when the second test packet is returned. The measurement unit 112 judges the link is communication NG, in which the first test packet is returned and the second test packet is not returned. In addition, the measurement unit 112 judges that the link is the measurement failure, in which neither the first test packet nor the second test packet is returned. The measurement unit 112 stores the judgement result together with the measurement date and time in the measurement result database 140 (see FIG. 3).

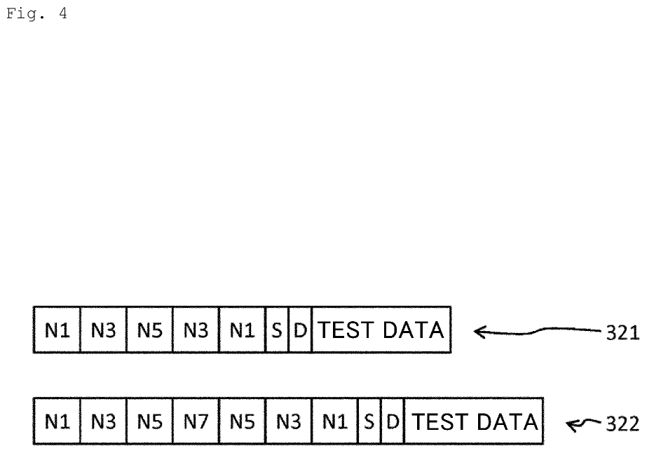

FIG. 4 is a diagram showing a configuration of test packet 321 and test packet 322 according to the present embodiment. In the headers of the test packet 321 and test packet 322, the identification information of a passing node is stored in addition to a transmission source (“S” in FIG. 4) and a transmission destination (“D” in FIG. 4). Both the transmission source and transmission destination of test packet are the abnormal node specification device 100.

When measuring the communication of link 310 (see FIG. 2) having the node N5 and node N7 as both ends, the abnormal node specification device 100 transmits the test packet 321 as the first test packet and the test packet 322 as the second test packet to the network 300. Note that since the abnormal node specification device 100 is connected to the node N1, the test packet 321 and test packet 322 are transmitted to the node N1.

The test packet 321 is transmitted to the network 300, and is returned to the abnormal node specification device 100 through the node N1, node N3, node N5, node N3, and node N1. The test packet 321 is returned to be folded back at the node N5. The test packet 322 is transmitted to the network 300, and is returned to the abnormal node specification device 100 through the node N1, node N3, node N5, node N7, node N5, node N3, and node N1. The test packet 322 is returned to be folded back at the node N7. When the test packet 322 passing through the link 310 is returned, the measurement unit 112 judges that it is communication OK. When the test packet 321 is returned and the test packet 322 is not returned, it is considered that there is the abnormality in the link 310 which becomes a difference, and the measurement unit 112 judges that it is communication NG. When neither the test packet 321 nor test packet 322 is returned, it is considered that there is a problem in the path from the abnormal node specification device 100 to the node N5, and the measurement unit 112 judges that it is the measurement failure.

The analysis unit 113 specifies the abnormal node on the basis of a communication result of link. In detail, when a part of links connected to the node is communication NG and the other links are the measurement failures, the analysis unit 113 judges that the node is abnormal. In other words, when the link which is communication NG is present in the links connected to the node and the link connected to the node other than the link is the measurement failure, the analysis unit 113 judges that the node is abnormal.

### Measurement Processing

FIG. 5 is a flowchart showing measurement processing according to the present embodiment. The measurement processing is performed at predetermined timing, for example, periodically. The measurement processing may be continuously and repeatedly performed.

In a step S11, the measurement unit 112 repeats a step S12 to step S14 for each link of the network 300. Hereinafter, the link which is a repeated processing target is referred to as a processing target link.

In the step S12, the measurement unit 112 refers to the network information database 130 to specify the shortest path to each of two nodes which are end points of the processing target link. In the following description, a node corresponding to a short (low cost) path is referred as a first node, and the other node is referred as a second node among the two shortest paths.

In the step S13, the measurement unit 112 generates the first test packet and the second test packet for the processing target link to transmit them. The first test packet passes through the shortest path to the first node specified in the step S12, is folded back at the first node, and is returned through the shortest path (see the test packet 321 described in FIG. 4). The second test packet passes through the shortest path, the first node, and the processing target link, is folded back at the second node, and is returned through the processing target link, the first node, and the shortest path (see the test packet 322).

In the step S14, the measurement unit 112 receives the first test packet and the second test packet transmitted in the step S13, judges the communication (communication OK, communication NG, or measurement failure), and records the result in the measurement result database 140. Note that when the test packet is not returned after waiting for a predetermined time, it is judged that the test packet has been lost.

### Abnormal Node Specification Processing

FIG. 6 is a flowchart of abnormal node specification processing according to the present embodiment. The abnormal node specification processing is performed at predetermined timing, for example, periodically. The abnormal node specification processing may be executed at timing when one measurement processing (see FIG. 5) is ended.

In a step S21, the analysis unit 113 refers to the measurement result database 140 to acquire the latest communication measurement result (communication OK, communication NG, or measurement failure) of all links in the network 300.

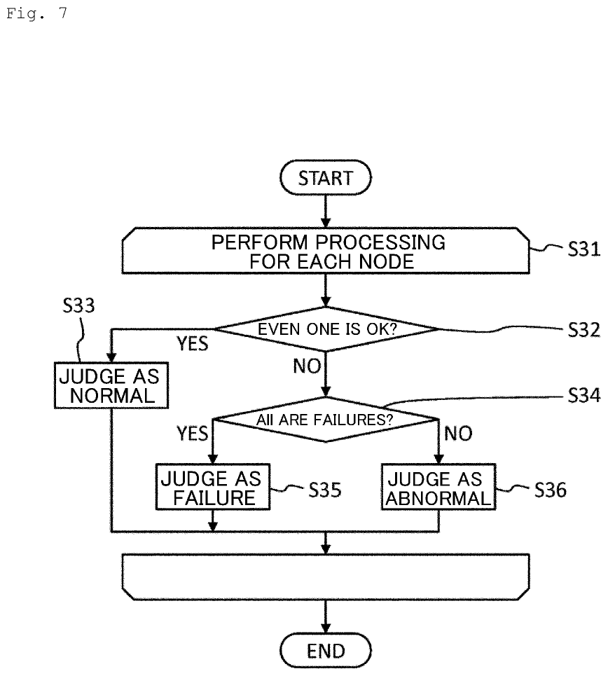

In a step S22, the analysis unit 113 executes node judgement processing (see FIG. 7) to be described later.

In a step S23, the analysis unit 113 ends the abnormal node specification processing when a node (see a step S36 in FIG. 7) judged to be abnormal in the node judgement processing in the step S22 is not present (step S23→NO), and proceeds to a step S24 when it is present (step S23→YES).

In the step S24, the analysis unit 113 updates a link which is communication NG having the abnormal node as the end point to the measurement failure in the communication measurement result acquired in the step S21.

In a step S25, the analysis unit 113 executes the node judgement processing.

### Node Judgement Processing

FIG. 7 is a flowchart of node judgement processing according to the present embodiment. The node judgement processing of the step S22 and step S25 will be described with reference to FIG. 7.

In a step S31, the analysis unit 113 repeats a step S32 to step S36 for each node in the network 300. Hereinafter, a node which is a repeated processing target is referred to as a processing target node.

In the step S32, the analysis unit 113 refers to the communication measurement result to proceed to the step S33 when even one link which is communication OK is present among the links connected to the processing target node (step S32→YES), and to proceed to the step S34 when it is not present (step S32→NO). Note that the communication measurement result is a communication measurement result acquired in the step S21 in the case of node judgement processing in the step S22, and is the communication measurement result updated in the step S24 in the case of node judgement processing in the step S25.

In the step S33, the analysis unit 113 judges that the processing target node is normal, and records it in the analysis result database 150.

In the step S34, the analysis unit 113 refers to the communication measurement result to proceed to the step S35 when all links which are the processing target nodes are the measurement failures (step S34→YES), and to proceed to the step S36 when all links are not the measurement failures (step S34→NO).

In the step S35, the analysis unit 113 judges that the processing target node is the measurement failure, and records it in the analysis result database 150.

In the step S36, the analysis unit 113 judges that the processing target node is abnormal, and records it in the analysis result database 150.

When a link which is communication OK is present among links connected to the processing target node, the processing target node is judged to be normal, when all links which are the measurement failures are present, it is judged to be the measurement failure, and when a link which is communication NG is present, it is judged to be abnormal.

### Path of Test Packet

The measurement unit 112 refers to the latest communication measurement result to determine the path of test packet so as to avoid the path which is communication NG. By repeating the measurement by determining the path in this way, even a link can be measured, in which the communication measurement result is the measurement failure due to the occurrence of abnormality in the node and the loss of the test packet through the node. An example of turning a measurement failure into a measurement availability is described below.

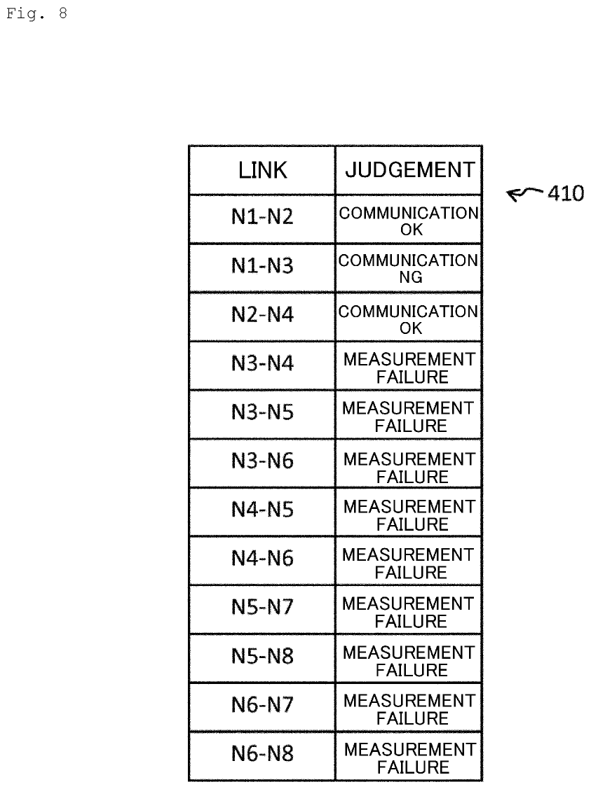

FIG. 8 is a diagram showing a communication measurement result 410 immediately after the occurrence of abnormality in the node N3 (see FIG. 2) according to the present embodiment. The communication measurement result 410 is a result obtained by acquiring the latest communication measurement result of the link obtained by removing the identification information and the measurement date and time from the measurement result database 140 (see FIG. 3). When the node and link of the network 300 (see FIG. 2) are normal, the test packet from the abnormal node specification device 100 to the node N4 to node N8 passes through the node N3 where the path cost is the minimum. For this reason, when the abnormality occurs in the node N3, the measurement failure occurs.

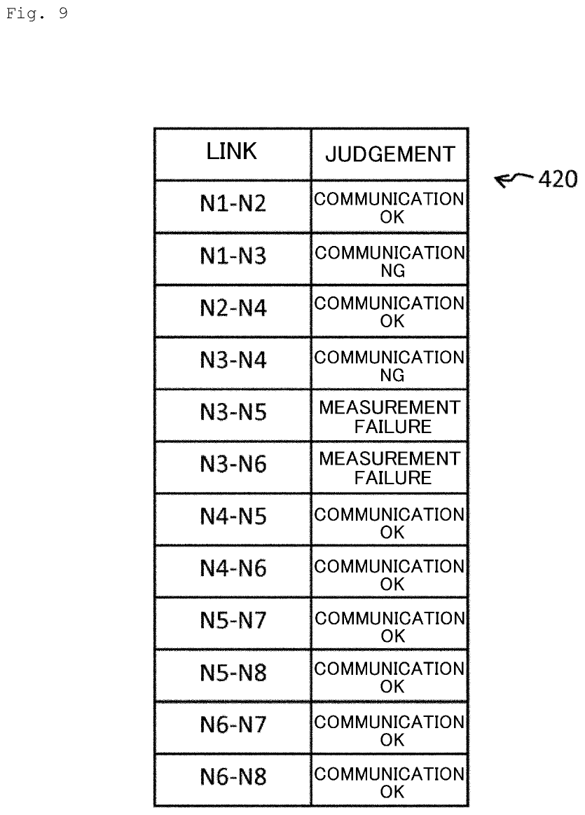

FIG. 9 is a diagram showing a communication measurement result 420 after one round from the occurrence of abnormality in the node N3 according to the present embodiment. After one round means after the measurement unit 112 transmits the test packet while avoiding the link between the node N1 and node N3 which are communication NG in the communication measurement result 410. The links between the node N4 to node N8 passes through the node N4 while avoiding the link between the node N1 and node N3, can be measured, and are communication OK.

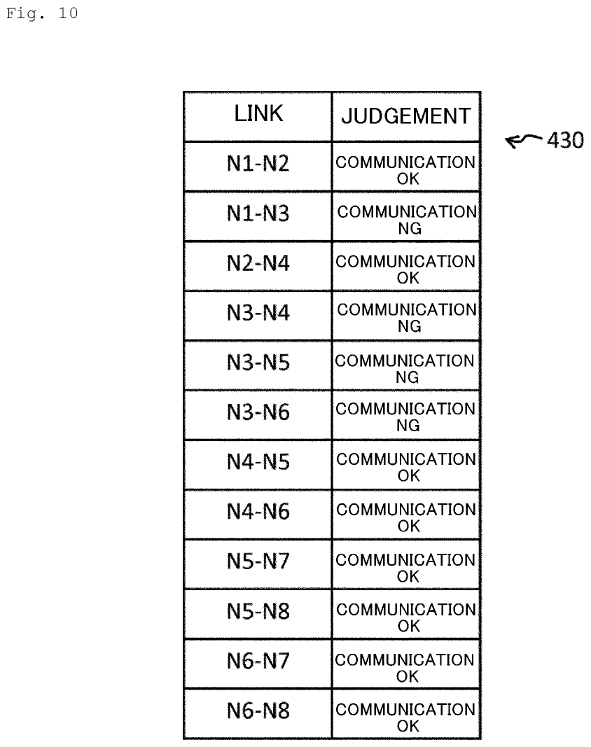

FIG. 10 is a diagram showing a communication measurement result 430 after two rounds from the occurrence of abnormality in the node N3 according to the present embodiment. After two rounds means after the test packet is transmitted while avoiding the link between the node N1 and node N3 and the link between the node N3 and node N4 which are communication NG in the communication measurement result 420. A link which is the measurement failure is eliminated, and a link having the node N3 as the end point is communication NG.

The measurement unit 112 repeats the measurement processing (see FIG. 5) thereafter, but the communication measurement result 430 continues even after three rounds. By repeating the measurement processing in this way, the number of links which are the measurement failure is reduced. Eventually, the number of cases where it is judged to be the measurement failure in the node judgement processing (see step S34→YES and S35 described in FIG. 7) is reduced, and the number of cases where the abnormal node is not specified is reduced.

### Features of Abnormal Node Specification Device

The abnormal node specification device 100 performs communication measurement of all links included in the network 300 by using the test packet, and specifies the abnormal node on the basis of the communication measurement result. The abnormal node specification device 100 designates the node through which the test packet passes, and judges the communication of link by using two test packets to be folded back at two nodes which are both ends of the link.

Subsequently, the abnormal node specification device 100 judges the abnormality of node on the basis of the communication measurement result of the link connected to the node.

By designating the node through which the test packet passes, one abnormal node specification device 100 can judges the communication between all links, and the cost can be reduced. Since the test packet is processed as a user packet (packet including user data of the network 300), node abnormality which affects the user packet transfer processing and cannot be detected by the intra-node monitoring can be detected. Also, by measuring all paths including the standby path through which the user packet does not normally pass, abnormality detection of the standby path and abnormality which cannot be detected by the monitoring function of node can be detected. Eventually, the abnormal location can be quickly specified.

### Modification Example

In the above, some embodiments of the present invention have been described, but those embodiments are just examples, and do not limit the technical scope of the present invention. For example, in the measurement processing (see FIG. 6), the test packets are transmitted and received sequentially for each link to perform the measurement, but the test packets may be transmitted and received in parallel for a plurality of links to perform the measurement. In addition, in the above embodiment, only one abnormal node specification device 100 is installed, but it is also possible to be installed at a plurality of locations and perform the communication measurement of link in a shared manner.

The present invention can take various other embodiments, and various changes such as omission and substitution can be made without departing from the gist of the present invention. These embodiments and modifications thereof are included in the scope and gist of the invention described in the present specification and the like and are also included in the scope of the invention described in the claims and the equivalent scope thereof.

### Hardware Configuration

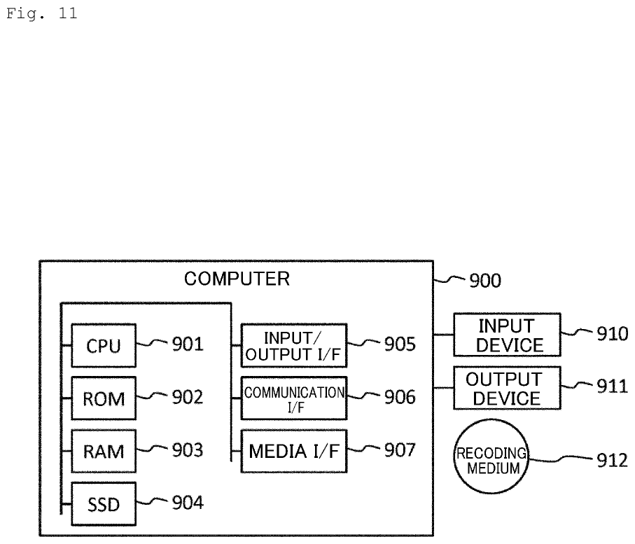

The above abnormal node specification device 100 according to the embodiment is realized by, for example, a computer 900 having a configuration as shown in FIG. 11. FIG. 11 is a hardware configuration diagram showing one example of the computer 900 that realizes the functions of abnormal node specification device 100 according to the present embodiment. The computer 900 includes a CPU 901, a ROM 902, a RAM 903, an SSD 904, an input/output interface 905 (described as an input/output I/F (Interface) in FIG. 11), a communication interface 906 (described as a communication I/F in FIG. 11), and a media interface 907 (described as a media I/F in FIG. 11). The computer 900 may include an HDD (Hard Disc Drive) instead of the SSD 904, or may further include the HDD in addition to the SSD 904.

The CPU 901 operates on the basis of a program stored in the ROM 902 or the SSD 904 and performs control by the control unit 110 in FIG. 1. The ROM 902 stores a boot program executed by the CPU 901 when the computer 900 is started, a program related to hardware of the computer 900, and the like. The CPU 901 controls an input device 910 such as a mouse and a keyboard and an output device 911 such as a display and a printer via the input/output interface 905. The CPU 901 acquires data from the input device 910 and outputs generated data to the output device 911 via the input/output interface 905.

The SSD 904 stores programs executed by the CPU 901, data used by the programs, and the like. The communication interface 906 receives data from other devices such as a node N1 to node N8 via the network 300 to output the data to the CPU 901, and transmits data generated by the CPU 901 to other devices via the communication network.

The media interface 907 reads the program or data stored in a recording medium 912 to output them to the CPU 901 via the RAM 903. The CPU 901 loads the program from the recording medium 912 on the RAM 903 via the media interface 907 to execute the loaded program. The recording medium 912 is an optical recording medium such as a DVD (Digital Versatile Disk), a magneto-optical recording medium such as an MO (Magneto Optical disk), a magnetic recording medium, a conductor memory tape medium, a semiconductor memory, or the like.

For example, when the computer 900 functions as the above abnormal node specification device 100 according to the embodiment, the CPU 901 of the computer 900 realizes the function of the abnormal node specification device 100 by executing the program 128 (see FIG. 1) loaded on the RAM 903. The CPU 901 reads the program from the recording medium 912 to execute the program. In addition, the CPU 901 may read the program from other devices via the communication network or may install the program 128 from the recording medium 912 to the SSD 904 to execute it.

### Effects

Effects of the abnormal node specification device 100 will be described below.

The above abnormal node specification device 100 according to the embodiment includes the measurement unit that transmits the first test packet (see test packet 321 described in FIG. 4) to be folded back at the first node which is the end point of link of the network 300 and the second test packet (see test packet 322) to be folded back at the second node which is another end point through the first node and the link, judges that the link is communication OK when the second test packet is returned, judges that the link is communication NG when the first test packet is returned and the second test packet is not returned, and judges that the link is the measurement failure when neither the first test packet nor the second test packet is returned.

In addition, the abnormal node specification device 100 includes the analysis unit 113 that judges that the node is abnormal when a link which is communication NG is present in the links connected to the node of the network 300 and a link connected to the node other than the link is the measurement failure.

According to such an abnormal node specification device 100, one abnormal node specification device 100 can judge the communication between all links to judge the abnormality of node, and the cost can be reduced. Since the test packet is processed as the user packet (packet including user data of the network 300), node abnormality which affects the user packet transfer processing and cannot be detected by the intra-node monitoring can be detected. Also, by measuring all paths including the standby path through which the user packet does not normally pass, abnormality detection of the standby path and abnormality which cannot be detected by the monitoring function of node can be detected. Eventually, the abnormal location can be quickly specified.

In the above abnormal node specification device 100 according to the embodiment, in the first test packet and the second test packet, passing nodes are designated, and the path to first node is the same.

According to such an abnormal node specification device 100, it is possible to judge the communication of link which is a measurement target regardless of the path to first node.

In the above abnormal node specification device 100 according to the embodiment, the measurement unit 112 repeats the measurement for each link of the network 300, and the path to first node does not include the link judged as communication NG.

According to such an abnormal node specification device 100, loss of the test packet in the path to first node can be avoided, and the number of measurement failures of link which is the measurement target can be reduced.

In the above abnormal node specification device 100 according to the embodiment, the path to designated first node is the shortest path or the path having the minimum cost.

According to such an abnormal node specification device 100, the load on the network 300 due to the measurement can be reduced.

### REFERENCE SIGNS LIST

100 Abnormal node specification device
111 Network information acquisition unit
112 Measurement unit
113 Analysis unit
128 Program
130 Network information database
140 Measurement result database
150 Analysis result database
300 Network
310 Link
321, 322 Test packet
N1 to N8 Node

1. An abnormal node specification device comprising:
a measurement unit configured to transmit a first test packet to be folded back at a first node which is an end point of a link of a network and a second test packet to be folded back at a second node which is another end point through the first node and the link,
determine that the link is communication OK based on the second test packet being returned,
determine that the link is communication NG based on the first test packet being returned and the second test packet not being returned, and
determine that the link is a measurement failure based on neither the first test packet nor the second test packet being returned; and
an analysis unit configured to determine that a node is abnormal based on a link which is communication NG being present in links connected to the node of the network and a link connected to the node other than the link being the measurement failure.

2. The abnormal node specification device according to claim 1, wherein
in the first test packet and the second test packet, passing nodes are designated, and a path to the first node is the same.

3. The abnormal node specification device according to claim 2, wherein
the measurement unit is configured to repeat a measurement for each link of the network, and
the path to the first node does not include a link determined as communication NG.

4. The abnormal node specification device according to claim 2, wherein
the path to the first node is the shortest path or the path with a minimum cost.

5. program causing a computer to function as the abnormal node specification device according to claim 1.

6. An abnormal node specification method causing an abnormal node specification device to execute the steps of:
transmitting a first test packet to be folded back at a first node which is an end point of a link of a network and a second test packet to be folded back at a second node which is another end point through the first node and the link,
determining that the link is communication OK based on the second test packet being returned,
determining that the link is communication NG based on the first test packet being returned and the second test packet not being returned, and
determining that the link is a measurement failure based on neither the first test packet nor the second test packet being returned; and
determining that a node is abnormal based on a link which is communication NG being present in links connected to the node of the network and a link connected to the node other than the link being the measurement failure.
